(19) United States
(12) Patent Application Publication
(10) Pub. No.: US 2008/0258430 A1
(43) Pub. Date: Oct. 23, 2008

(54) Connection for Trailer

(76) Inventor: Mark Mathews, New South Wales (AU)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/718,824

(22) PCT Filed: Nov. 8, 2005
(86) PCT No.: PCT/AU2005/001707

§ 371 Date: Oct. 30, 2007

(30) Foreign Application Priority Data
Nov. 9, 2004 (AU) 2004906431

(51) Int. Cl. B60D 1/14; B62D 53/00

(52) U.S. Cl. 280/416.2; 280/408

(57) ABSTRACT

A hitch connection for connecting a lead or “A” trailer to a “B” trailer is disclosed. The hitch connection comprises a female sub-assembly which fits inside the chassis of the “A” trailer at the rear of that trailer. A male sub-assembly which includes a turnplate supported on a chassis includes a tapered prong which locates in the female assembly and is held inside with locking pins. The prong includes a transverse pivot which extends parallel to the axle to allow the prong to pivot relative to the chassis

The “B” trailer may be readily separated from the “A” trailer by removal of the locking pins to allow removal of the prong from the female sub-assembly thus allowing unfettered access to the rear of the “A” trailer. The hitch connection may also be used for towing a single trailer behind a non-articulated truck having a fixed body

### CROSS-REFERENCE TO RELATED APPLICATIONS

The present application claims priority from Australian Provisional Patent 2004906431 filed on 9 Nov. 2004, the content of which is incorporated herein by reference.

### FIELD OF THE INVENTION

This invention relates to a connection for a trailer.

### BACKGROUND OF THE INVENTION

In Australia, and particularly in outback areas, it is common for a single rig to pull two trailers. The lead or “A” trailer is mounted on a turntable to the rig and the second or “B” trailer is mounted on a turntable so that it can rotate relative to the “A” trailer.

The problem with such an arrangement, is that the “B” trailer travels very close behind the “A” trailer, so in the case of say refrigerated vans where the van is loaded from the rear, access to the rear of the van for loading the “A” trailer is very limited. In order to provide better access to the “A” for loading it is necessary to unhitch the “B” trailer, which, with existing systems, is a complicated, time consuming and consequently, relatively expensive process.

It is an object of the present invention to address or at least alleviate the problems of the prior art as discussed above.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### SUMMARY OF THE INVENTION

According to a first aspect of the present invention, there is provided a releasable connection means for connecting a second trailer to a first trailer comprising:

a female sub-assembly, the female sub-assembly defining a slot for receiving a prong and means for mounting the sub-assembly in the chassis of a trailer;

a male sub-assembly including a chassis defining a turnplate for attachment of the second trailer thereto mounted on top of the chassis, and including a prong extending away from the chassis for insertion in the slot of the female sub-assembly; and

locking means for locking the prong inside the slot preventing relative movement of the same.

The advantage of the present invention is that the prong may be removed from the slot to separate the second trailer from the rear of the lead trailer thereby allowing access to the rear of the lead trailer. This enhances the loading/unloading capabilities of lead trailers by forklift or the like, an allows easier unloading by means of rear tipping.

Typically, the prong tapers from a relatively wider end at the chassis to a relatively narrower free end which defines one or more apertures for receiving a locking pin. In like manner the slot tapers from a relatively wider open end to a relatively narrower, typically closed, end which defines one or more apertures for receiving the locking pin, thereby locking the prong in the slot.

Typically, the prong has a generally rectangular cross-section and tapers in height and width, and the slot likewise has a generally rectangular cross-section and tapers in height and width.

It is preferred that the prong defines wear surfaces at each end, said wear surfaces having a slope of from about 12 to 18°.

when the locking pin is inserted and held in the apertures the prong and slot may be secured together by means of a spring loaded ram operated by compressed air acting on the pin.

In a related aspect the present invention provides a vehicle and trailer assembly comprising:

a prime mover defining a first turnplate;

a lead trailer having a chassis mounted on the first turnplate;

a female sub-assembly, the female sub-assembly defining a slot having an open end for receiving a prong fitted in the chassis of the lead trailer at the rear of the trailer;

a male sub-assembly including a chassis defining a second turnplate for attachment of the second trailer thereto mounted on top of the chassis, and including a prong extending away from the chassis for insertion in the slot of the female sub-assembly;

locking means for rigidly locking the prong inside the slot and preventing relative movement of the same; and

a second trailer mounted on the second turnplate of the male sub-assembly.

The present invention may also be used for towing a single trailer behind a non-articulated truck having a fixed body, thus in a further aspect, there is provided a vehicle and trailer assembly comprising:

a non-articulated truck having a chassis;

a female sub-assembly, the female sub-assembly defining a slot having an open end for receiving a prong fitted in the chassis of the rear end of the truck;

a male sub-assembly including a chassis defining a turnplate for attachment of a trailer thereto mounted on top of the chassis, and including a prong extending away from the chassis for insertion in the slot of the female sub-assembly;

locking means for rigidly locking the prong inside the slot and preventing relative movement of the same; and

a trailer mounted on the turnplate of the male sub-assembly.

### BRIEF DESCRIPTION OF THE DRAWINGS

A specific embodiment of the present invention will now be described by way of example only and with reference to the accompanying drawings in which:

FIG. 1 illustrates a “B” double trailer arrangement comprising a rig or tractor unit, an “A” trailer and a “B” trailer;

FIG. 2 is a schematic drawing of the rear of an “A” trailer with a hitch connection means embodying the present invention attached;

FIG. 3 shows the hitch connection means disconnected from the “A” trailer;

FIG. 4 shows a rig with the “B” trailer disconnected from the “A” trailer illustrating improved access to the rear of the “A” trailer enabling tipping from the “A” trailer;

FIG. 5 is a plan view of male and female components of the embodiment of the hitch connection; and

FIG. 6 is a side elevation of male and female components of the embodiment of the hitch connection.

### DETAILED DESCRIPTION OF A PREFERRED EMBODIMENT

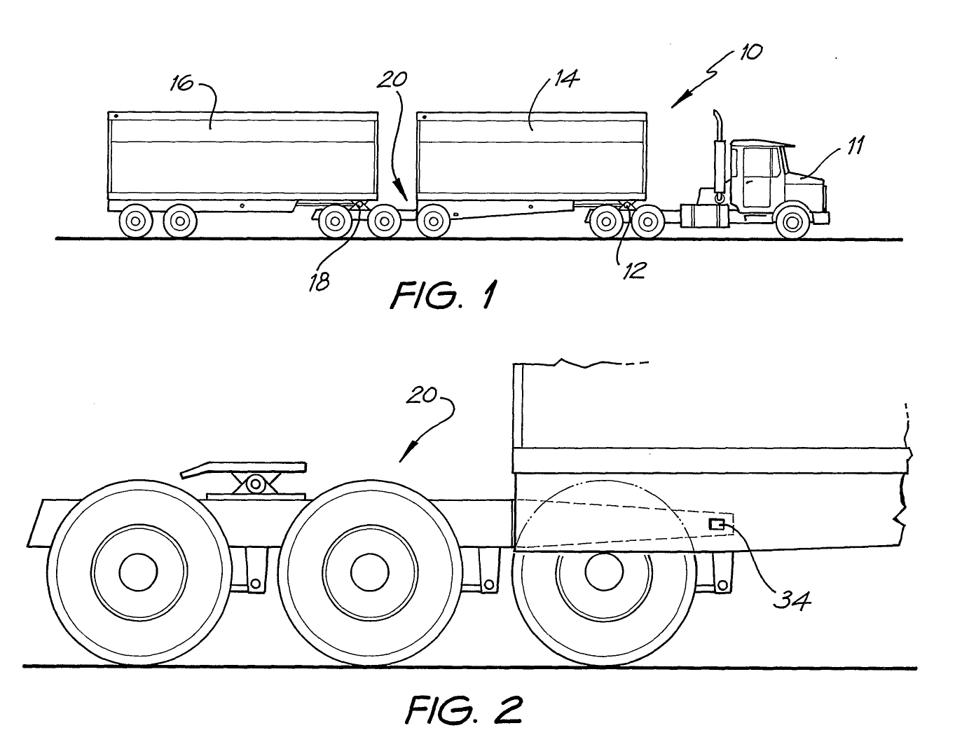

Referring to the drawings, FIG. 1 shows a prime mover 11 defining a turnplate 12 on which a lead or “A” trailer is mounted. The prime mover and trailer assembly also includes a “B” trailer 16 which is mounted to a turnplate 18 which forms part of a rigid hitch connection means 20 embodying the present invention.

With reference to FIGS. 2 and 3 the connection means 20 comprises a male sub-assembly 22 and a female sub-assembly 24. The female sub-assembly fits inside the chassis 26 of the trailer 14, and is locked in position by a pair of pins (27), described in more detail below.

The male sub-assembly includes a chassis 28 supported on a pair of axles and wheels 30. The turnplate 18 for attachment of a “B” trailer is mounted on top of the chassis 28. An elongate prong 32 extends away from the chassis 28 and defines a slot 34 at one end. The prong is insertable into the female sub-assembly 24 fitted inside the chassis of the “A” trailer.

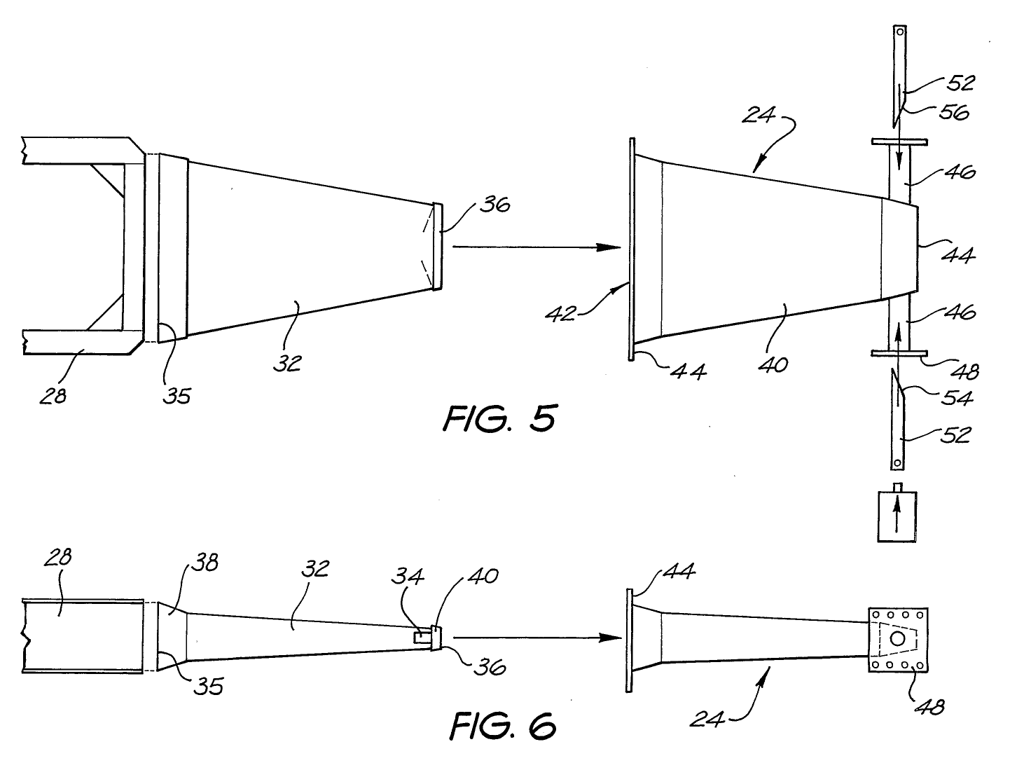

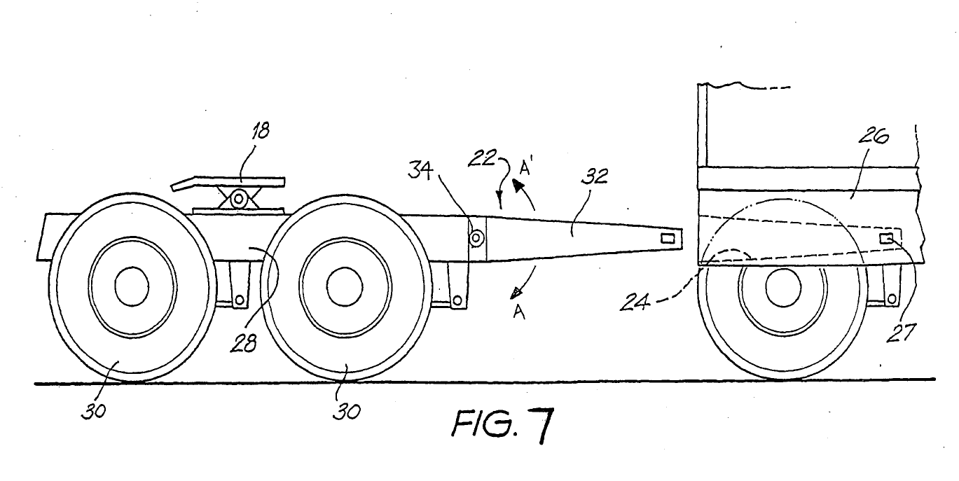

FIGS. 5 and 6 show the male and female elements in more detail in plan and elevation, respectively.

One, relatively wider, end 35 of the prong 32 is welded to the chassis 28. The prong has a generally rectangular cross-section which tapers in both height and width from the wider end 35 to a narrower free end 36. The ends 34 and 36 define wear surfaces which have a slope of about 12 to 18°. The male element is welded to the chassis 26 defines two contact areas/wear surfaces at the base and tip of the male prong, 38 and 40 respectively, each having a 12 to 18° slope, but which could be varied. The wear surfaces function is to resist damage to the prong as it is inserted and removed from the female sub-assembly.

The female sub-assembly 24 comprises a tapered slot having a rectangular cross-section which sized and configured to receive the prong 32 in a relatively close fit, defining a relatively wider open end 42 and a, relatively narrower, closed end 44. A mounting flange 44 is welded the wider end 42 of the tapered slot. Two tubes 46 extend away from the relatively narrower end 44 at the end of which mounting plates 48 are located. The mounting plates/flanges 44, 48 are used for mounting the female sub-assembly to the chassis 26.

Also illustrated in FIGS. 5 and 6 are two round pins 50 having tapered flats 52 which are used to lock the prong 32 inside the slot 40 and which passes through holes 27 in the slot and 34 in the prong. Typically a spring loaded air ram 54 will be used to hold the pin in place

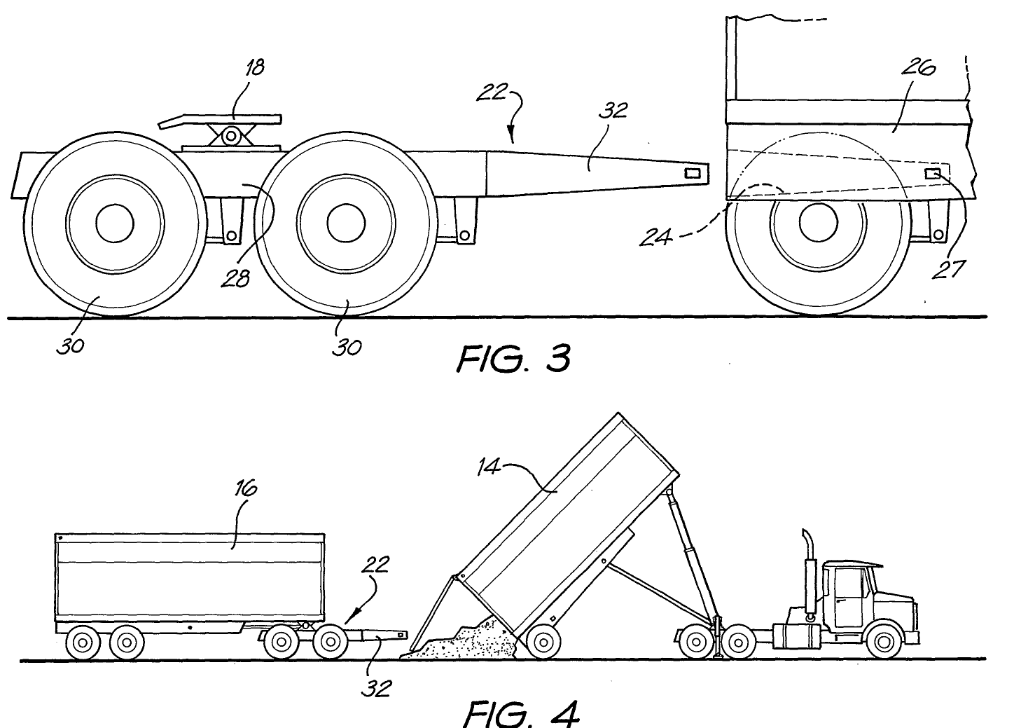

In use the female sub-assembly is first fitted inside the chassis at the rear of the lead or “A” trailer and welded in place as shown in FIG. 3. The prong 32 of the male sub-assembly is then inserted in the female subassembly of the “A” trailer and locked by means of the locking pins passing through the slots 34 in the tip of the prong and 27 in the slot. Once locked the connection is rigid and strong enough to pull a “B” trailer via the turnplate 18. The locking pins an then be simply removed to allow the separation of the “B” trailer from the “A” trailer by removal of the prong from the slot easy access to the rear of the “A” trailer. FIG. 4 illustrates the separation of a “B” trailer from a lead trailer to allow rear tipping of the lead trailer.

It will be appreciated that the connection means of the present invention could also be used between a second and third trailer of a road train, and between a non-articulated truck towing a trailer.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A releasable connection means for connecting a second trailer to a first trailer comprising:
a female sub-assembly, in the form of a tapering sleeve having an open end for receiving a prong and means for mounting the sub-assembly in the chassis of a trailer;
a male sub-assembly including a chassis defining a turnplate for attachment of the second trailer thereto mounted on top of the chassis, and including a prong having a relatively wider end proximal to the chassis and a narrower distal end extending away from the chassis configured for insertion in the sleeve defined by the female sub-assembly;
wherein the tapering prong defines a longitudinal axis and defines a first wear surface at or adjacent its wider end and a second wear surface spaced apart from the first wear surface and located at or near the distal end of the prong;
and wherein the prong defines a slot extending transverse to its longitudinal axis for receiving a locking pin;
and at least one locking pin for rigidly locking the prong inside the sleeve and preventing movement of the prong relative to the sleeve.

2. A releasable connection means as claimed in claim 1 wherein the prong has a generally rectangular cross-section and tapers in height and width and wherein the first and second wear surfaces extend around the prong.

3. A releasable connection means as claimed in claim 2 wherein the sleeve has a generally rectangular cross-section and tapers in height and width.

4. A releasable connection means as claimed in claim 1 wherein the locking pin is inserted and held in the apertures securing the prong and slot together by means of a spring loaded ram operated by compressed air.

5. A releasable connection means as claimed in claim 1 wherein the first wear surface slope at an angle of 12 to 18 degrees relative to the longitudinal axis of the prong.

6. A releasable connection means as claimed in claim 1 wherein the second wear surface slopes at an angle of 12 to 18 degrees relative to the longitudinal axis of the prong.

7. A releasable connection means as claimed in claim 1 wherein the locking pins define tapered flats.

8. A releasable connection means as claimed in claim 1 wherein the prong includes a transverse pivot which extends parallel to the axle to allow the prong to pivot relative to the chassis

9. A vehicle and trailer assembly comprising:
a prime mover defining a first turnplate;
a lead trailer having a chassis mounted on the first turnplate;
a female sub-assembly in the form of a tapering sleeve having an open end for receiving a prong fitted in the chassis of the lead trailer at the rear of the trailer;
a male sub-assembly including a chassis defining a second turnplate for attachment of a second trailer thereto mounted on top of the chassis, and including a prong having a relatively wider end proximal to the chassis and a narrower distal end extending away from the chassis configured for insertion in the sleeve defined by the female sub-assembly;
wherein the tapering prong defines a longitudinal axis and defines a first wear surface at or adjacent its wider proximal end and a second wear surface spaced apart from the first wear surface and located at or near the distal end of the prong;
and wherein the prong defines a slot extending transverse to its longitudinal axis for receiving a locking pin;
at least one locking pin rigidly locking the prong inside the sleeve and preventing movement of the prong relative to the sleeve; and
a second trailer mounted on the second turnplate of the male sub-assembly.

10. A vehicle and trailer assembly as claimed in claim 9 wherein the prong includes a transverse pivot which extends parallel to the axle to allow the prong to pivot relative to the chassis

11. A vehicle and trailer assembly comprising:
a non-articulated truck having a chassis;
a female sub-assembly in the form of a tapering sleeve having an open end for receiving a prong fitted in the chassis of the rear end of the truck;
a male sub-assembly including a chassis defining a turnplate for attachment of a trailer thereto mounted on top of the chassis, and including a prong having a relatively wider end proximal to the chassis and a narrower distal end extending away from the chassis configured for insertion in the sleeve defined by the female sub-assembly;
wherein the tapering prong defines a longitudinal axis and defines a first wear surface at or adjacent its wider proximal end and a second wear surface spaced apart from the first wear surface and located at or near the distal end of the prong;
and wherein the prong defines a slot extending transverse to its longitudinal axis for receiving a locking pin;
at least one locking pin rigidly locking the prong inside the sleeve and preventing movement of the prong relative to the sleeve; and and
a trailer mounted on the turnplate of the male sub-assembly.

12. A vehicle and trailer assembly as claimed in claim 1wherein the prong includes a transverse pivot which extends parallel to the axle to allow the prong to pivot relative to the chassis
